(19) United States
(12) Patent Application Publication
(10) Pub. No.: US 2023/0066224 A1
(43) Pub. Date: Mar. 2, 2023

(54) METAL AIR BATTERY SYSTEM

(71) Applicant: MITSUBISHI HEAVY INDUSTRIES, LTD., Tokyo (JP)

(72) Inventors: Yoshinori NOGUCHI, Tokyo (JP); Toshiyasu KIYABU, Tokyo (JP)

(73) Assignee: MITSUBISHI HEAVY INDUSTRIES, LTD., Tokyo (JP)

(21) Appl. No.: 17/797,306

(22) PCT Filed: Mar. 12, 2021
(86) PCT No.: PCT/JP2021/010043

§ 371 Date: Aug. 3, 2022

(30) Foreign Application Priority Data
Mar. 19, 2020 (JP) 2020-049139

(51) Int. Cl. H01M 12/06; H01M 4/96; H01M 4/90

(52) U.S. Cl. CPC H01M 12/06; H01M 4/96; H01M 4/9016

(57) ABSTRACT

A metal air battery system is provided with: a battery device including a negative electrode, a metal body electrically connected to the negative electrode, and a positive electrode and having a chamber which is defined between the negative electrode and the metal body and through which an electrolytic solution flows; an oxygen separation device for separating oxygen from air; and a bubbling device for supplying a gas containing oxygen separated by the oxygen separation device into the electrolytic solution supplied to the chamber while bubbling the gas.

### TECHNICAL FIELD

The present disclosure relates to a metal air battery system.

### BACKGROUND

Patent Document 1 discloses a metal air battery system in which oxygen is used as a positive electrode active material and metal is used as a negative electrode active material. In this metal air battery system, oxygen as the positive electrode active material is dissolved in an electrolyte by bubbling air into an electrolytic solution in a tank.

### CITATION LIST

### Patent Literature

Patent Document 1: JP5659675B

### SUMMARY

### Problems to be Solved

However, in order to increase the discharge current density in a metal air battery system, it is necessary to increase the dissolved oxygen concentration in the electrolytic solution, but simply bubbling air into the electrolytic solution limits the ability to increase the dissolved oxygen concentration, making it difficult to achieve a desired discharge current density.

In view of the above, an object of at least one embodiment of the present disclosure is to provide a metal air battery system that can increase the discharge current density.

### Solution to the Problems

To achieve the above object, a metal air battery system according to the present disclosure comprises: a battery device including a negative electrode, a metal body electrically connected to the negative electrode, and a positive electrode and having a chamber which is defined between the negative electrode and the metal body and through which an electrolytic solution flows; an oxygen separation device for separating oxygen from air; and a bubbling device for supplying a gas containing oxygen separated by the oxygen separation device into the electrolytic solution supplied to the chamber while bubbling the gas.

### Advantageous Effects

According to the metal air battery system of the present disclosure, since oxygen is dissolved in the electrolytic solution by bubbling the gas with higher oxygen concentration than air into the electrolytic solution, the dissolution rate of oxygen into the electrolytic solution can be increased as compared to bubbling the air into the electrolytic solution. As a result, the discharge current density can be increased.

### BRIEF DESCRIPTION OF DRAWINGS

FIG. 1 is a schematic configuration diagram of a metal air battery system according to the first embodiment of the present disclosure.

FIG. 2 is a schematic configuration diagram of a metal air battery system according to the second embodiment of the present disclosure.

### DETAILED DESCRIPTION

Hereinafter, a metal air battery system according to embodiments of the present disclosure will be described with reference to the drawings. The following embodiments are illustrative and not intended to limit the present disclosure, and various modifications are possible within the scope of technical ideas of the present disclosure.

### First Embodiment

### <Configuration of Metal Air Battery System According to First Embodiment>

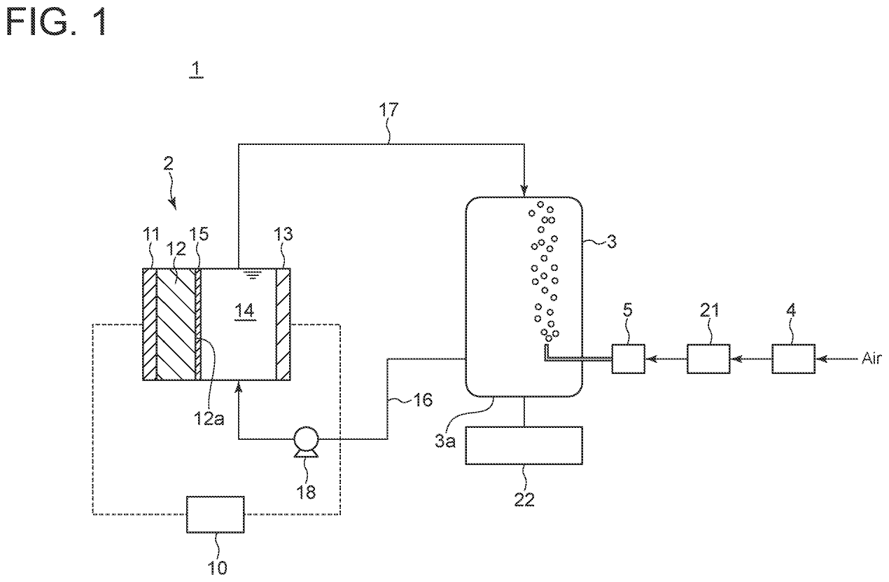

As shown in FIG. 1, a metal air battery system 1 according to the first embodiment of the present disclosure includes a battery device 2, an electrolytic solution tank 3 storing an electrolytic solution, an oxygen separation device 4 for separating oxygen from air, and a bubbling device 5 for supplying a gas containing oxygen separated by the oxygen separation device 4 into the electrolytic solution stored in the electrolytic solution tank 3 while bubbling the gas. The battery device 2 includes a negative electrode 11, a metal body 12 electrically connected to the negative electrode 11, and a positive electrode 13 and has a chamber 14 which is defined between the negative electrode 11 and the metal body 12. Each of the negative electrode 11 and the positive electrode 13 is electrically connected to a load 10. A separator 15 is disposed on a surface 12a of the metal body 12 which defines the chamber 14. As the positive electrode 13, a hydrophilic-treated electrode carrying an oxygen reduction catalyst is used.

As the oxygen reduction catalyst, in an acidic liquid environment, a catalyst mainly containing platinum as an active ingredient (e.g., platinum-supported carbon) may be used. In an alkaline liquid environment, a catalyst containing a 3d transition metal such as iron, manganese, nickel, or cobalt or an oxide thereof as an active ingredient may be used. In addition, a catalyst containing ruthenium, silver, gold, or iridium as an active ingredient can be used in both an acidic liquid environment and an alkaline liquid environment. Further, a catalyst containing an organic metal complex, carbon fiber (e.g., carbon nanotube), nitrogen carbide, or the like as an active ingredient can also be used.

The electrolytic solution tank 3 and the chamber 14 may be communicated with each other through an electrolytic solution supply line 16 and an electrolytic solution return line 17. In this case, for example, by providing a pump 18 in the electrolytic solution supply line 16, the electrolytic solution in the electrolytic solution tank 3 can be supplied to the chamber 14 through the electrolytic solution supply line 16. The electrolytic solution then flows through the chamber 14, is discharged from the chamber 14, and is returned to the electrolytic solution tank 3 through the electrolytic solution return line 17, so that the electrolytic solution circulates between the electrolytic solution tank 3 and the chamber 14.

Alternatively, the electrolytic solution tank 3 and the chamber 14 may be communicated with each other only through the electrolytic solution supply line 16. In this case, the electrolytic solution supplied from the electrolytic solution tank 3 to the chamber 14 through the electrolytic solution supply line 16 flows through the chamber 14, is discharged from the chamber 14, and then is sent to a facility other than the electrolytic solution tank 3 through a discharge line (not shown). In this case, the electrolytic solution does not circulate between the electrolytic solution tank 3 and the chamber 14. Also in this case, by providing a pump 18 in the electrolytic solution supply line 16, the electrolytic solution in the electrolytic solution tank 3 can be supplied to the chamber 14 through the electrolytic solution supply line 16, or instead of the pump 18, head pressure may be used to supply the electrolytic solution. However, the configuration in which the electrolytic solution circulates between the electrolytic solution tank 3 and the chamber 14 can reduce the amount of electrolytic solution used and thus reduce the cost, as compared to the configuration in which the electrolytic solution does not circulate between the electrolytic solution tank 3 and the chamber 14.

The configuration of the oxygen separation device 4 is not particularly limited. The oxygen separation device may have any configuration, such as a pressure swing adsorption (PSA) type device, a temperature swing adsorption (TSA) type device, or a membrane separation device.

As the electrolytic solution, either an aqueous electrolytic solution, in which an electrolyte is dissolved in water, or a non-aqueous electrolytic solution, in which an electrolyte is dissolved in a non-aqueous solution such as an organic solvent, can be used. Examples of the aqueous electrolytic solution include an aqueous solution containing an electrolyte such as a hydroxide, a chloride, a phosphate, a borate, or a sulfate of potassium, sodium, lithium, barium, magnesium, etc. That is, any supporting salt for imparting electrical conductivity of the aqueous solution can be used as the electrolyte. Examples of the non-aqueous electrolytic solution include a solution in which a supporting salt such as alkali metal is dissolved in a liquid such as a cyclic or chain carbonate, a cyclic or chain ester, a cyclic or chain ether, a sulfone compound, or an ionic liquid.

In FIG. 1, the metal body 12 is depicted as having a plate-like structure, but the metal body 12 is not limited to this embodiment, and may be a porous substrate plated with metal. As the material of the metal body 12, zinc, iron, aluminum, lithium, sodium, potassium, copper, magnesium, or an alloy thereof may be used. When an aqueous electrolytic solution is used as the electrolytic solution, zinc, iron, aluminum, copper, or an alloy thereof is preferably used as the material of the metal body 12. When a non-aqueous electrolytic solution is used as the electrolytic solution, lithium, sodium, potassium, magnesium, or an alloy of thereof is preferably as the material of the metal body 12, and a solid electrolyte membrane is preferably used as the separator 15.

The gas bubbled by the bubbling device 5 is a gas containing oxygen separated by the oxygen separation device 4. Thus, since oxygen is dissolved in the electrolytic solution by bubbling the gas with higher oxygen concentration than air, the dissolved oxygen concentration in the electrolytic solution can be increased as compared to bubbling the air into the electrolytic solution.

As the bubbling device 5, it is preferable to use a device that can bubble the gas containing oxygen separated by the oxygen separation device 4 with an average value of bubble diameter of 100 μm or less. Since the bubble diameter and the pressure inside bubble are inversely proportional to each other, the pressure inside bubble increases as the bubble diameter decreases. Further, the dissolution rate of a gas into a liquid is proportional to the pressure. Therefore, the smaller the bubble diameter, the higher the dissolution rate of the gas into the liquid. By using the bubbling device 5 that can supply the gas with an average bubble diameter of 100 μm or less, the dissolution rate of oxygen into the electrolytic solution can be increased as compared to simply bubbling the gas containing oxygen.

Although not an essential configuration, the metal air battery system 1 may be provided with a carbon dioxide removal device 21, disposed between the electrolytic solution tank 3 and the oxygen separation device 4, for removing carbon dioxide from the gas containing oxygen separated by the oxygen separation device 4. The carbon dioxide removal device 21 may be disposed upstream of the oxygen separation device 4 to remove carbon dioxide from air to be supplied to the oxygen separation device 4. In either case, the gas with reduced carbon dioxide concentration can be bubbled into the electrolytic solution, as compared with the case where the carbon dioxide removal device 21 is not provided. The configuration of the carbon dioxide removal device 21 is not particularly limited, and may be, for example, a device configured to cause carbon dioxide to be absorbed in an absorption liquid such as an amine aqueous solution or a device configured to cause carbon dioxide to be adsorbed on a solid absorption agent. Similarly, although not an essential configuration, the metal air battery system 1 may be provided with a recovery container 22 communicating with a bottom portion 3a of the electrolytic solution tank 3

<Operation of Metal Air Battery System According to First Embodiment>

Next, the operation of the metal air battery system 1 according to the first embodiment of the present disclosure will be described. The oxygen separation device 4 separates oxygen from air, and the bubbling device 5 supplies a gas containing the separated oxygen into an electrolytic solution stored in the electrolytic solution tank 3 while bubbling the gas. As a result, oxygen is dissolved in the electrolytic solution stored in the electrolytic solution tank 3, and the dissolved oxygen concentration in the electrolytic solution increases.

When the pump 18 is started, the electrolytic solution stored in the electrolytic solution tank 3 flows into the chamber 14 through the electrolytic solution supply line 16. The electrolytic solution then flows through the chamber 14, is discharged from the chamber 14, and is returned to the electrolytic solution tank 3 through the electrolytic solution return line 17, so that the electrolytic solution circulates between the electrolytic solution tank 3 and the chamber 14. Taking an alkaline liquid environment as an example, at this time, as shown by the following reaction formula (M is a metal atom), metal elements constituting the metal body 12 react with hydroxides in the electrolytic solution to form metal hydroxides and release electrons to the negative electrode 11.

M+20H⁻→M(OH)₂+2e⁻ Positive electrode:

On the other hand, oxygen dissolved in the electrolytic solution becomes hydroxide ions by receiving electrons from the positive electrode 13, as shown by the following reaction formula.

O₂+2H₂O+4e⁻→4OH⁻ Negative electrode:

Overall, the metal hydroxides generated as shown by the following reaction formula are deposited on the surface of the metal body 12. This reaction creates a potential difference between the negative electrode 11 and positive electrode 13, and causes current to flow to the load 10.

2M+O₂+2H₂O→2M(OH)₂ Overall:

In order to increase the discharge current density of the metal air battery system 1, it is necessary to increase the dissolved oxygen concentration or the dissolution rate of oxygen in the electrolytic solution. In the metal air battery system 1, since oxygen is dissolved in the electrolytic solution by bubbling the gas with higher oxygen concentration than air, the dissolved oxygen concentration in the electrolytic solution can be increased as compared to bubbling the air into the electrolytic solution. As a result, the discharge current density can be increased.

Additionally, when the device that can supply the gas with an average bubble diameter of 100 μm or less is used as the bubbling device 5, the discharge current density can be further increased as compared to simply bubbling the gas containing oxygen.

The gas bubbled into the electrolytic solution stored in the electrolytic solution tank 3 is a gas containing oxygen separated from air by the oxygen separation device 4, but since the air contains carbon dioxide, there is a possibility that this gas also contains carbon dioxide. If such a gas is bubbled into the electrolytic solution, carbon dioxide is dissolved in the electrolytic solution. If carbon dioxide is dissolved in the electrolytic solution, metal ions eluted in the electrolytic solution during the discharge react with carbon dioxide, which adversely affects the battery performance. In this regard, when the metal air battery system 1 is provided with the carbon dioxide removal device 21, since the gas with reduced carbon dioxide concentration is supplied to the electrolytic solution, the dissolved concentration of carbon dioxide in the electrolytic solution is reduced, so that the possibility of adversely affecting the battery performance can be reduced.

Metal oxides, which are reactants of metal ions with oxygen ions, and metal carbonates, which are reactants of metal ions with carbon dioxide, i.e., metal ion precipitates, are partially suspended in the electrolytic solution and circulate between the electrolytic solution tank 3 and chamber 14 together with the electrolytic solution. While the electrolytic solution is stored in the electrolytic solution tank 3, the metal ion precipitates settle at the bottom. When the recovery container 22 communicating with the bottom portion 3a of the electrolytic solution tank 3 is provided, the metal ion precipitates can be recovered by the recovery container 22, so that the recovered metal ion precipitates can be reused as the material of the metal body 12.

In the first embodiment, the bubbling device 5 supplies the gas containing oxygen separated by the oxygen separation device 4 into the electrolytic solution stored in the electrolytic solution tank 3 while bubbling the gas, but the bubbling device 5 is not limited to this embodiment. The bubbling device 5 may bubble the gas into the electrolytic solution flowing through the electrolytic solution supply line 16 between the pump 18 and the chamber 14. According to this configuration, the possibility that bubbles of the bubbled gas are sucked into the pump 18 can be reduced, so that the possibility that the pump 18 fails can be reduced. On the other hand, with the configuration of bubbling into the electrolytic solution stored in the electrolytic solution tank 3, sufficient time can be secured for oxygen to dissolve in the electrolytic solution, so that the electrolytic solution with dissolved oxygen can be reliably supplied to the chamber.

### Second Embodiment

Next, a metal air battery system according to the second embodiment will be described. The metal air battery system according to the second embodiment is obtained by modifying the configuration of the battery device 2 according to the first embodiment. In the second embodiment, the same constituent elements as those in the first embodiment are associated with the same reference numerals and not described again in detail.

<Configuration of Metal Air Battery System According to Second Embodiment>

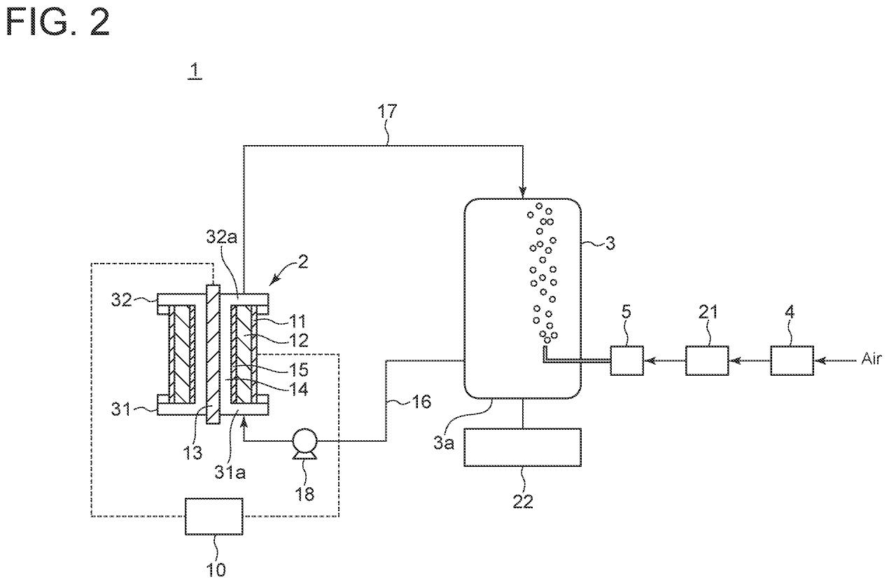

As shown in FIG. 2, in the metal air battery system 1 according to the second embodiment of the present disclosure, the battery device 2 has a cylindrical shape in which the metal body 12 and the negative electrode 11 are disposed so as to surround the positive electrode 13. A chamber 14 having a ring-shaped cross-section is formed between the positive electrode 13 and the metal body 12.

Electrolyte solution distribution flanges 31, 32 are provided at both ends of this cylindrical shape in the axial direction. Internal spaces 31a, 32a communicating with the chamber 14 are formed inside the electrolytic solution distribution flanges 31, 32, respectively. The internal spaces 31a and 32a communicate with the electrolytic solution supply line 16 and the electrolytic solution return line 17, respectively. The configuration is otherwise the same as that of the first embodiment. Modifications of each constituent element in the first embodiment can also apply to the second embodiment.

<Operation of Metal Air Battery System According to Second Embodiment>

When the electrolytic solution stored in the electrolytic solution tank 3 is introduced into the internal space 31a through the electrolytic solution supply line 16 by the pump 18, it flows into the chamber 14 from the internal space 31a, flows through the chamber 14, and then flows into the internal space 31b. The electrolytic solution discharged from the internal space 31b is returned to the electrolytic solution tank 3 through the electrolytic solution return line 17. Thus, the electrolytic solution circulates between the electrolytic solution tank 3 and the chamber 14.

The dissolution action of oxygen into the electrolytic solution, the discharge principle of the battery device 2, and the operation when the carbon dioxide removal device 21 and the recovery container 22 are provided are the same as those in of the first embodiment. Therefore, the metal air battery system 1 according to the second embodiment provides the same effect as the first embodiment.

In the first embodiment, the negative electrode 11 and the positive electrode 13 are depicted as each having a flat plate shape, and one chamber 14 is formed between the metal body 12 and the positive electrode 13, but, in practice, the arrangements of the negative electrode 11, the metal body 12, the positive electrode 13, and the chamber 14 are very complicated, and the flow of the electrolytic solution in the chamber 14 is also complicated. In contrast, in the metal air battery system 1 according to the second embodiment, unlike the first embodiment, the battery device 2 has a cylindrical shape in which the metal body 12 and the negative electrode 11 are disposed so as to surround the positive electrode 13. This configuration allows the flow path of the electrolytic solution in the battery device 2, i.e., the chamber 14, to have a simple configuration that extends in the axial direction of the cylindrical shape. Thus, it is possible to reduce the pressure loss of the electrolytic solution, and further, it is possible to reduce the possibility that gas is accumulated in the battery device 2 when gas such as oxygen dissolved in the electrolytic solution is dissipated. Further, by sealing both ends of the cylindrical shape of the battery device 2, the battery device 2 can be sealed, which provides excellent sealing and reduces the risk of leakage of the electrolytic solution.

In the first and second embodiments, when the metal air battery system 1 is operated in a long time, the above-described electrochemical reaction no longer occurs. In this situation, by connecting the negative electrode 11 and the positive electrode 13 to a power source instead of the load 10 and applying a voltage between the electrodes, the battery device 2 can be charged. On the other hand, instead of such a charging operation, by replacing the metal body 12 with a new one, the battery device 2 can be discharged again. In this case, the metal body 12 needs to be interchangeably attached to the negative electrode 11. The battery device 2 can be used as a secondary battery as in the former, or as a primary battery as in the latter.

<Modification of Metal Air Battery System of Present Disclosure>

The oxygen separation device 4 may be eliminated from the first and second embodiments. The only component of the gas used in the chamber 14 is oxygen, but the air also contains nitrogen, carbon dioxide, and argon. Carbon dioxide is preferably removed because it adversely affects the battery performance. On the other hand, since nitrogen and argon are inert gases, the presence of nitrogen and argon in the gas does not adversely affect the battery performance, although there is a disadvantage that the oxygen concentration in the gas is decreased. Therefore, the metal air battery system 1 according to the first and second embodiments can adopt a configuration in which the oxygen separation device 4 is removed while the carbon dioxide removal device 21 is provided.

In the second embodiment, the metal body 12 and the negative electrode 11 are disposed so as to surround the positive electrode 13, but the positive electrode 13 may be disposed so as to surround the metal body 12 and the negative electrode 11.

Considering the operating environment of the metal air battery system of the present disclosure, it may be necessary to further reduce the diameter of bubbles supplied to the electrolytic solution to achieve higher performance. For example, when the limiting current density of the metal air battery system is 500 mA/cm², the gas dissolution rate in the electrolytic solution needs to be about 6.5×10⁻³ mol/sec. Considering this with a bubble content of 1% or more, the bubble diameter of the supplied gas is preferably 5 μm or less.

If it is necessary to increase the limiting current density in the metal air battery system, it is necessary to reduce the bubble diameter based on the dissolution rate of the gas (oxygen gas) required. Thus, the condition of the bubbles supplied to the electrolytic solution is defined by the limiting current density of the metal air battery system. The relationship between the limiting current density and the bubble condition is shown in Table 1 below.

TABLE 1

| Limiting | Oxygen gas | Number | Bubble | Bubble |
|---|---|---|---|---|
| current density | dissolution rate | of bubbles | diameter | content |
| (mA/cm2) | (mol/sec) | (×10⁸ bubbles/L) | (μm) | (vol %) |
| 500 | 6.5 × 10⁻³ | 1236 | 10 | 6.4 |
| 500 | 6.5 × 10⁻³ | 1236 | 5 | 0.8 |
| 500 | 6.5 × 10⁻³ | 1236 | 1 | 0.006 |
| 100 | 1.3 × 10⁻³ | 247 | 10 | 1.3 |
| 100 | 1.3 × 10⁻³ | 247 | 5 | 0.13 |
| 100 | 1.3 × 10⁻³ | 247 | 1 | 0.001 |
| 1 | 1.3 × 10⁻⁵ | 2.4 | 100 | 12.9 |
| 1 | 1.3 × 10⁻⁵ | 2.4 | 10 | 0.013 |

According to Table 1, for example, when the limiting current density is 500 mA/cm², if the bubble diameter (average bubble diameter) supplied to the electrolytic solution is 10 μm, the required bubble content is 6.4 vol % or more, and if the bubble diameter supplied to the electrolytic solution is 5 μm, the required bubble content is 0.8 vol % or more. In other words, the smaller the bubble diameter, the smaller the required bubble content for operation with a high limiting current density. Since the general bubble content of microbubbles is less than 10 vol %, it is desirable to operate with a bubble diameter that results in a bubble content of less than 10 vol %, depending on the operating current density and the limiting current density.

### Examples

The effect of the difference in the bubble diameter of the gas supplied into the electrolytic solution on the discharge current density was examined. As the electrolytic solution, 2 cc of 1 mol/L KOH aqueous solution was put into each of five sealed batch cells. As shown in Table 2 below, in batch cells 1 to 3, air (oxygen concentration 21%) was supplied into the KOH aqueous solution under the conditions of average bubble diameter and bubble content (23° C. (22° C. for batch cell 3 only)) described in Table 2. Air was supplied with a microbubble generator in order to achieve the conditions of batch cells 1 and 2. Air was supplied with a diffuser tube in order to achieve the conditions of batch cell 3. In batch cells 4 and 5, air was not supplied into the KOH aqueous solution, but in batch cell 5, argon gas was supplied into the KOH aqueous solution for 1 hour or more to degas.

TABLE 2

| | | | Dissolved | | |
|---|---|---|---|---|---|
| | Average | Bubble | oxygen | Oxygen reduction current | |
| Batch | bubble | content | concentration | density (mA/cm²) | |
| cell | diameter | (vol %) | (ppm) | (10 mV/sec) | (20 mV/sec) |
| 1 | 45 μm | 7.2 | 8.3 | 0.13 | 0.19 |
| 2 | 86 μm | 7.5 | 8.2 | 0.12 | 0.18 |
| 3 | several | — | 8.6 | 0.09 | 0.14 |
| | mm | | | | |
| 4 | — | — | 8.3 | 0.08 | 0.13 |
| 5 | — | — | 0.04 | 0.03 | 0.05 |

The dissolved oxygen concentration and the oxygen reduction current density were measured for each of the KOH aqueous solutions of batch cells 1 to 5. For the former measurement, a low-concentration portable dissolved oxygen meter (DO-32A) manufactured by DKK-TOA CORPORATION was used to measure the dissolved oxygen while sending the solution with bubbles to the measuring instrument at 100 ml/min. The temperature of the solution at that time was 23° C. (however, only batch cell 3 had a solution temperature of 22° C.). The latter was measured by linear sweep voltammetry in a three-electrode cell with a 3-mm diameter platinum as the working electrode, a platinum wire as the counter electrode, and Hg/HgO (1 MKOH) as the reference electrode, at potential sweep rates of 10 mV/sec and 20 mV/sec. The measurement results are also shown in Table 2.

Comparing batch cells 1 and 2 with batch cell 3 in terms of dissolved oxygen concentration, there was little effect of the difference in bubble diameter of the supplied gas. This is thought to be because the electrolytic solution was open to the atmosphere, and the dissolved oxygen concentration was a saturated concentration determined according to the temperature of the solution. In contrast, comparing batch cells 1 and 2 with batch cell 3 in terms of oxygen reduction current density, the formers are significantly higher than the latter. This is thought to be because, although oxygen reduction caused the dissolved oxygen in the solution to disappear and the dissolved oxygen concentration to decrease, in the bubble-supplied system, the dissolution of oxygen occurred from the bubbles along with the consumption of oxygen, resulting in a higher oxygen reduction current density. These results demonstrate that when the average bubble diameter of the gas supplied to the electrolytic solution is 100 μm or less, the discharge current density can be increased as compared to simply bubbling the gas.

The contents described in the above embodiments would be understood as follows, for instance.

[1] A metal air battery system according to an aspect comprises: a battery device (2) including a negative electrode (11), a metal body (12) electrically connected to the negative electrode (11), and a positive electrode (13) and having a chamber (14) which is defined between the negative electrode (11) and the metal body (12) and through which an electrolytic solution flows; an oxygen separation device (4) for separating oxygen from air; and a bubbling device (5) for supplying a gas containing oxygen separated by the oxygen separation device (4) into the electrolytic solution supplied to the chamber (14) while bubbling the gas.

According to the metal air battery system of the present disclosure, since oxygen is dissolved in the electrolytic solution by bubbling the gas with higher oxygen concentration than air into the electrolytic solution, the dissolution rate of oxygen into the electrolytic solution can be increased as compared to bubbling the air into the electrolytic solution. As a result, the discharge current density can be increased.

[2] A metal air battery system according to another aspect is the metal air battery system described in [1] in which an average value of bubble diameter of the gas supplied into the electrolytic solution by the bubbling device (5) is 100 μm or less.

Since the bubble diameter and the pressure inside bubble are inversely proportional to each other, the pressure inside bubble increases as the bubble diameter decreases. The dissolution rate of a gas into a liquid is proportional to the pressure. Therefore, the smaller the bubble diameter, the higher the concentration of the gas dissolved in the liquid. According to the above configuration [2], the dissolution rate of oxygen into the electrolytic solution can be increased as compared to simply bubbling the gas containing oxygen. As a result, the discharge current density can be increased.

[3] A metal air battery system according to still another aspect is the metal air battery system described in [2] in which a bubble content of the gas is less than 10 vol %.

According to this configuration, the dissolution rate of oxygen into the electrolytic solution can be increased as compared to simply bubbling the gas containing oxygen. As a result, the discharge current density can be increased.

[4] A metal air battery system according to still another aspect is the metal air battery system described in any of [1] to [3] comprising a carbon dioxide removal device (21) for removing carbon dioxide from the gas containing oxygen separated by the oxygen separation device (4) or air supplied to the oxygen separation device (4).

Since air contains carbon dioxide, there is a possibility that carbon dioxide is mixed in the gas containing oxygen separated by the oxygen separation device. If carbon dioxide is dissolved in the electrolytic solution, metal ions eluted in the electrolytic solution during the discharge react with carbon dioxide, which adversely affects the battery performance. In this regard, according to the above configuration [4], since the gas with reduced carbon dioxide concentration is supplied to the electrolytic solution, the dissolved concentration of carbon dioxide in the electrolytic solution is reduced, so that the possibility of adversely affecting the battery performance can be reduced.

[5] A metal air battery system according to still another aspect is the metal air battery system described in any of [1] to [4] comprising an electrolytic solution tank (3) storing the electrolytic solution. The bubbling device (5) supplies the gas into the electrolytic solution stored in the electrolytic solution tank (3) while bubbling the gas.

According to this configuration, sufficient time can be secured for oxygen to dissolve in the electrolytic solution, so that the electrolytic solution with dissolved oxygen can be reliably supplied to the chamber.

[6] A metal air battery system according to still another aspect is the metal air battery system described in any of [1] to [5] comprising: an electrolytic solution tank (3) storing the electrolytic solution; an electrolytic solution supply line (16) connecting the electrolytic solution tank (3) and the chamber (14); an electrolytic solution return line (17) connecting the electrolytic solution tank (3) and the chamber (14); and a pump (18) disposed in the electrolytic solution supply line (16).

According to this configuration, since the electrolytic solution circulates between the electrolytic solution tank and the chamber, it is possible to reduce the amount of electrolytic solution used and thus reduce the cost, as compared to the case of discarding the electrolytic solution that has flowed through the chamber.

[7] A metal air battery system according to another aspect is the metal air battery system described in [6] in which the bubbling device (5) bubbles the gas into the electrolytic solution flowing through the electrolytic solution supply line (16) between the pump (18) and the chamber (14).

According to this configuration, the possibility that bubbles of the bubbled gas are sucked into the pump can be reduced, so that the possibility that the pump fails can be reduced.

[8] A metal air battery system according to still another aspect is the metal air battery system described in any one of [5] to [7] comprising a recovery container (22) communicating with a bottom portion (3a) of the electrolytic solution tank (3).

According to this configuration, precipitates of metal ions eluted from the metal body can be recovered by the recovery container and can be reused as the material of the metal body.

[9] A metal air battery system according to still another aspect is the metal air battery system described in any one of [1] to [8] in which the battery device (2) has a cylindrical shape with the metal body (12) surrounding the positive electrode (13).

This configuration allows the flow path of the electrolytic solution in the battery device to have a simple configuration. Thus, it is possible to reduce the pressure loss of the electrolytic solution, and further, it is possible to reduce the possibility that gas is accumulated in the battery device when gas such as oxygen dissolved in the electrolytic solution is dissipated. Further, by sealing both ends of the cylindrical shape of the battery device, the battery device can be sealed, which provides excellent sealing and reduces the risk of leakage of the electrolytic solution.

[10] A metal air battery system according to an aspect comprises: a battery device (2) including a negative electrode (11), a metal body (12) electrically connected to the negative electrode (11), and a positive electrode (13) and having a chamber (14) which is defined between the negative electrode (11) and the metal body (12) and through which an electrolytic solution flows; a carbon dioxide removal device (21) for removing carbon dioxide from air; and a bubbling device (5) for supplying a gas obtained by removing carbon dioxide from the air into the electrolytic solution supplied to the chamber (14) while bubbling the gas.

According to the metal air battery system of the present disclosure, since the gas with lower carbon dioxide concentration than air is supplied to the electrolytic solution, the dissolved concentration of carbon dioxide in the electrolytic solution is reduced, so that the possibility of adversely affecting the battery performance can be reduced.

### REFERENCE SIGNS LIST

1 Metal air battery system
2 Battery device
3 Electrolytic solution tank
3a Bottom portion of (electrolytic solution tank)
4 Oxygen separation device
5 Bubbling device
11 Negative electrode
12 Metal body
13 Positive electrode
14 Chamber
16 Electrolytic solution supply line
17 Electrolytic solution return line
18 Pump
21 Carbon dioxide removal device
22 Recovery container

1. A metal air battery system, comprising:
a battery device including a negative electrode, a metal body electrically connected to the negative electrode, and a positive electrode and having a chamber which is defined between the negative electrode and the metal body and through which an electrolytic solution flows;
an oxygen separation device for separating oxygen from air; and
a bubbling device for supplying a gas containing oxygen separated by the oxygen separation device into the electrolytic solution supplied to the chamber while bubbling the gas,
wherein a bubble content of the gas supplied into the electrolytic solution by the bubbling device is less than 10 vol %.

2. The metal air battery system according to claim 1,
wherein an average value of bubble diameter of the gas supplied into the electrolytic solution by the bubbling device is 100 μm or less.

3. (canceled)

4. The metal air battery system according to claim 1, comprising a carbon dioxide removal device for removing carbon dioxide from the gas containing oxygen separated by the oxygen separation device or air supplied to the oxygen separation device.

5. The metal air battery system according to claim 1, comprising an electrolytic solution tank storing the electrolytic solution, wherein the bubbling device supplies the gas into the electrolytic solution stored in the electrolytic solution tank while bubbling the gas.

6. The metal air battery system according to claim 1, comprising:
an electrolytic solution tank storing the electrolytic solution;
an electrolytic solution supply line connecting the electrolytic solution tank and the chamber;
an electrolytic solution return line connecting the electrolytic solution tank and the chamber; and
a pump disposed in the electrolytic solution supply line.

7. The metal air battery system according to claim 6,
wherein the bubbling device bubbles the gas into the electrolytic solution flowing through the electrolytic solution supply line between the pump and the chamber.

8. The metal air battery system according to claim 5, comprising a recovery container communicating with a bottom portion of the electrolytic solution tank.

9. The metal air battery system according to claim 1,
wherein the battery device has a cylindrical shape with the metal body surrounding the positive electrode.

10. A metal air battery system, comprising:
a battery device including a negative electrode, a metal body electrically connected to the negative electrode, and a positive electrode and having a chamber which is defined between the negative electrode and the metal body and through which an electrolytic solution flows;
a carbon dioxide removal device for removing carbon dioxide from air; and
a bubbling device for supplying a gas obtained by removing carbon dioxide from the air into the electrolytic solution supplied to the chamber while bubbling the gas.

11. The metal air battery system according to claim 6, comprising a recovery container communicating with a bottom portion of the electrolytic solution tank.
